(19) United States
(12) Patent Application Publication
(10) Pub. No.: US 2014/0084663 A1
(43) Pub. Date: Mar. 27, 2014

(54) MOLDED SEAT

(71) Applicant: Mark TODD, Jacksonville, FL (US)

(72) Inventor: Mark TODD, Jacksonville, FL (US)

(21) Appl. No.: 13/624,905

(22) Filed: Sep. 22, 2012

(51) Int. Cl. A47C 7/20; B29C 70/70; B29C 70/84

(52) U.S. Cl. CPC A47C 7/20; B29C 70/84; B29C 70/70
USPC 297/452.48; 264/46.4

(57) ABSTRACT

The instant invention teaches a seat incorporating an insert or inserts intermediate its upper and lower surfaces. A seat insert adapted for the support of the users buttocks and/or upper thighs conforms to the contours of the user's body over a period of time, has certain “rebound” properties, and features an area adapted to underlie the perineum of a user seated on the seat, which area is softer than the rest of the seat insert either by virtue of an included gap in the seat insert or by virtue of a softer material filling said gap. Alternatively, a perineal insert of softer material may be used without the seat insert described. In either case, the aforesaid inserts are preferably completely encapsulated and enclosed by the foam materials making up the seat, which can be accomplished by molding the seat around the insert(s). These innovations enable the seat to be molded with various internal density control zones and to otherwise provide a more comfortable seat to the user with enhanced abilities to conform to the user's body and enhanced springiness, while limiting pressure on the user's perineum.

### BACKGROUND OF THE INVENTION

1. Field of the Invention

This invention pertains generally to seat bottoms and seat bottom construction, but may have mare general applicability to overall seat construction design and techniques. More specifically, the invention pertains to a molded seat bottom which incorporates and has been molded around an insert or inserts shaped in particular ways and comprised of particular materials chosen to impart desirable characteristics to the seat, and a method and system for producing a seat of this type.

2. Description of the Related Art

Polyurethane, produced by combining monomers including isocyanate functional groups and hydroxyl groups, is a known material for forming resilient seating of all types, including motorcycle seats. The combination process typically requires a catalyst and, for applications similar to those of interest in the instant invention, a mold of some type. In this process, liquid isocyanate and resin are blended at a specific ratio, and the reacting liquid is dispensed into the mold and allowed to cure, then the finished part is demolded. Typically, in high volume manufacturing applications, a dispensing unit is used to combine and dispense the reacting liquid into the mold used in forming the finished piece in a process commonly known as reaction injection molding (“RIM”).

Examples of prior art patents that may be found to have teachings relevant to the invention are:
(1) U.S. Pat. No. 3,787,278 for a “Molded Multiple Density Polyurethane Foam” issued Jan. 22, 1974, to Ready et al., describing molded, multiple density polyurethane foams and a process for their preparation.
(2) U.S. Pat. No. 4,572,856 for a “Composite Molded Article and Process Using Self-Positioning Laminated Stiffener” issued Feb. 25, 1986, to Gembinski, describing a stiffener insert incorporated into a molded composite article such as an automobile dashboard by inserting the stiffener insert between a pre-formed plastisol skin forming opposing mold walls.
   However, there is a continuing need for devices providing new and improved features in the field of the invention. Further, there are no prior art devices possessing the unique features and advantages inherent in my invention.

### SUMMARY OF THE INVENTION

The instant invention teaches a seat having insert(s) or “mat(s)” incorporated therein intermediate its upper and lower surfaces so as, in most cases, to be generally parallel to the upper surface of the seat (i.e., the surface on which the posterior of the user will rest). The primary embodiments of an insert/mat described herein is comprised of material that conforms to the contours of the user's body over a period of time, has certain “rebound” properties (or spring-like performance), and features an area adapted to underlie the perineum of a user seated on the seat, which area is softer than the rest of the insert either by virtue of an included gap in the insert or by virtue of a softer material filling said gap. In another embodiment of the invention, the insert is adapted and shaped to underly the perineum of a user and is comprised of a softer material than the surrounding foam. In the preferred embodiments taught herein, the aforesaid inserts are completely encapsulated and enclosed by the foam materials making up the seat with this being advantageously accomplished by molding the seat around the inserts. This is made possible, in accordance with the teachings of the invention, by providing means for suspending inserts within the mold used in forming the seat so as to be in proper spaced relationship to the upper surface of the seat (on which the user will be seated) and the lower surface of the seat (facing away from the seated user) when formed in the mold. Thus, my invention is enabled to provide a more comfortable seat for the user with—in the primary embodiments discussed—enhanced abilities to conform to the user's body and enhanced springiness, while limiting pressure on the perineum in all embodiments. In addition, the “integrated or molded in” aspect of the invention maintains the integrity of the exterior foam surfaces, in particular the upper surface of the seat/foam. In this manner, the essential “mechanics” or “workings” of my invention (as provided by insert) are “hidden” inside the foam making up the seat, with little or no interruption of the top surface in terms of aesthetics or the look/feel of upholstery fit, etc. Further, carefully selecting and designing the properties of the various foams involved, i.e., insert foam, perineal gap insert/foam, and surrounding foam, provides the ability to control the overall suspension effect with zone density control, to better adapt the final composite to the human anatomy and pressures for various applications. These goals and others are all accomplished in an efficient and economical manner using the method I have developed for molding the seat around an insert or inserts including and providing the characteristics described.

### BRIEF DESCRIPTION OF THE DRAWINGS

FIG. 1 provides a schematic perspective view of a mold and dispenser for forming an exemplary polyurethane seat in accordance with the teachings of prior art.

FIG. 2 provides a schematic perspective view of a first preferred embodiment of an exemplary seat insert in accordance with the teachings of my invention.

FIG. 3 provides a schematic perspective view of a second version of the first preferred embodiment of a seat insert in accordance with the teachings of my invention.

FIG. 4 provides a schematic perspective view of the mold and dispenser of FIG. 1 as adapted for placement and support of a seat insert therein by inclusion of appropriately spaced and configured support pegs in accordance with the teachings of my invention.

FIG. 5 provides a schematic perspective view of the mold and dispenser including appropriately spaced and configured support pegs as illustrated in FIG. 4 with the seat insert appropriately mounted thereon in accordance with the teachings of my invention.

FIG. 6 provides another schematic perspective view of the mold and dispenser including appropriately spaced and configured support pegs as illustrated in FIG. 4 with the seat insert appropriately mounted thereon in accordance with the teachings of my invention.

FIG. 7 provides a schematic perspective view of the mold and dispenser including appropriately spaced and configured support pegs as illustrated in FIG. 4 with a second seat insert embodiment appropriately mounted thereon in accordance with the teachings of my invention.

FIG. 8 provides a schematic cross-sectional perspective view of an exemplary motorcycle seat with integral seat insert formed in accordance with the teachings of my invention.

FIG. 9 provides a schematic perspective view of the mold and dispenser including appropriately spaced and configured support pegs for and with a perineal insert appropriately mounted thereon in accordance with the teachings of my invention.

FIG. 10 provides a schematic cross-sectional perspective view of an exemplary motorcycle seat with integral perineal insert formed in accordance with the teachings of my invention.

### DESCRIPTION

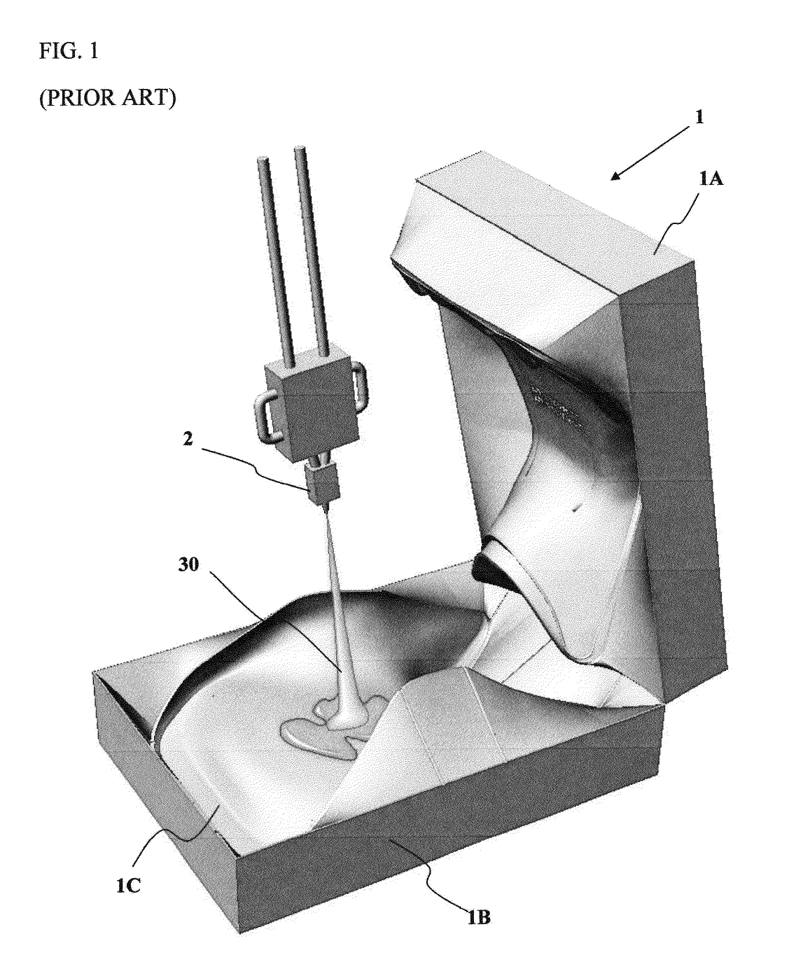

The process, construction and apparatus used in the instant invention can best be understood by careful and ordered review of the above-referenced drawing figures, beginning with FIG. 1, which illustrates a mold 1 having an upper mold part 1A and a lower mold part 1B, defining a hollow mold space 1C (in the desired shape of a motorcycle seat in this case) when closed together. (The motorcycle seat shown in the drawing figures provides an example of how the teachings of the invention can be applied in this context, but should not be seen as limiting the scope of the inventive concept to this particular type of seating). As illustrated, and in accordance with the prior discussion of the reaction injection molding process, a dispensing unit 2 is used to combine and dispense the reacting liquid 30 into the mold 1 used in forming the finished piece, a polyurethane motorcycle seat (not illustrated), in accordance with the teachings of prior art. Once an appropriate amount of liquid 30 is dispensed into mold space 1C, the mold is closed, and the reacting liquid 30 expands to fully fill the mold space 1C, taking the desired form/shape of a motorcycle seat as defined by the shape of mold space 1C.

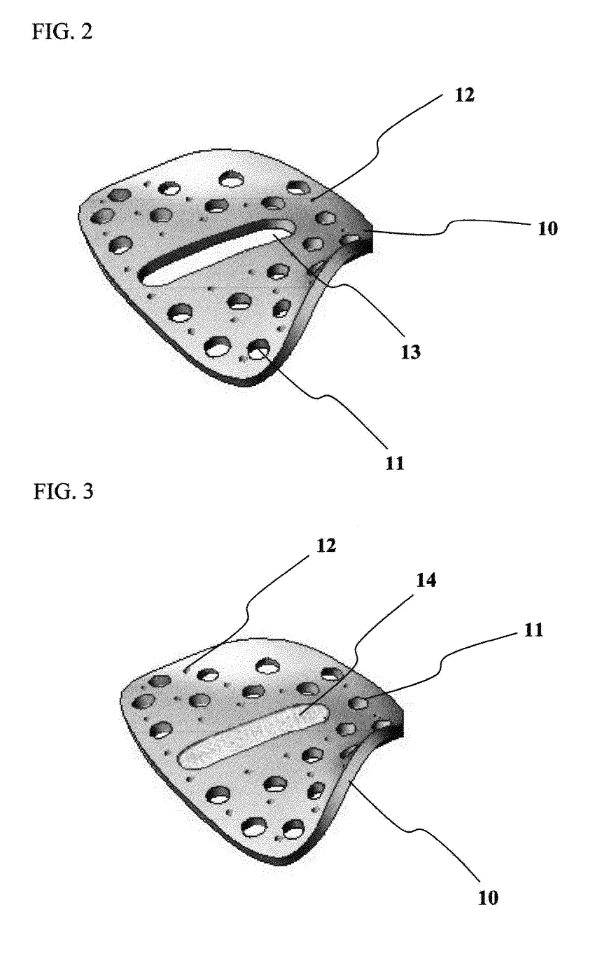

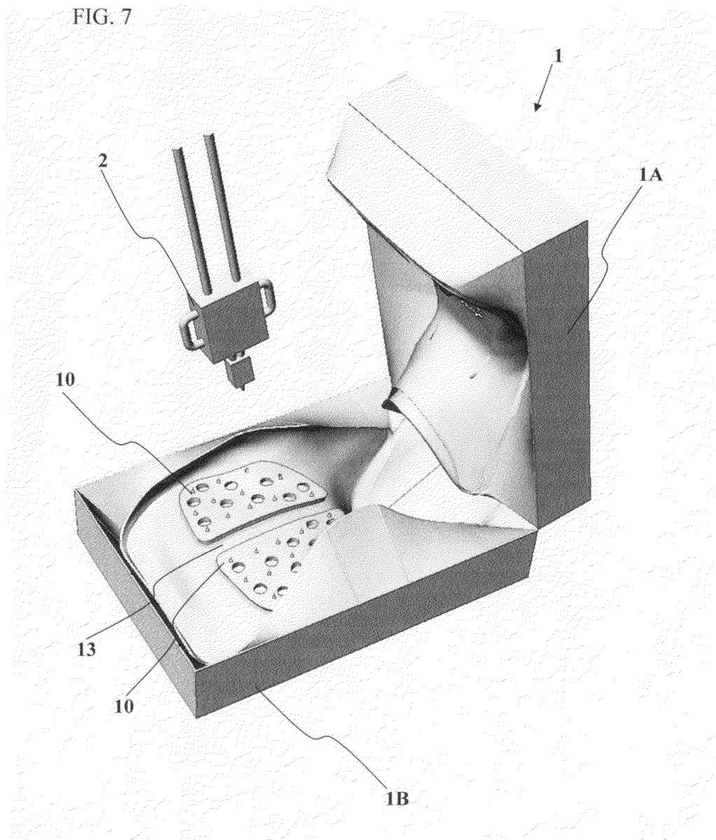

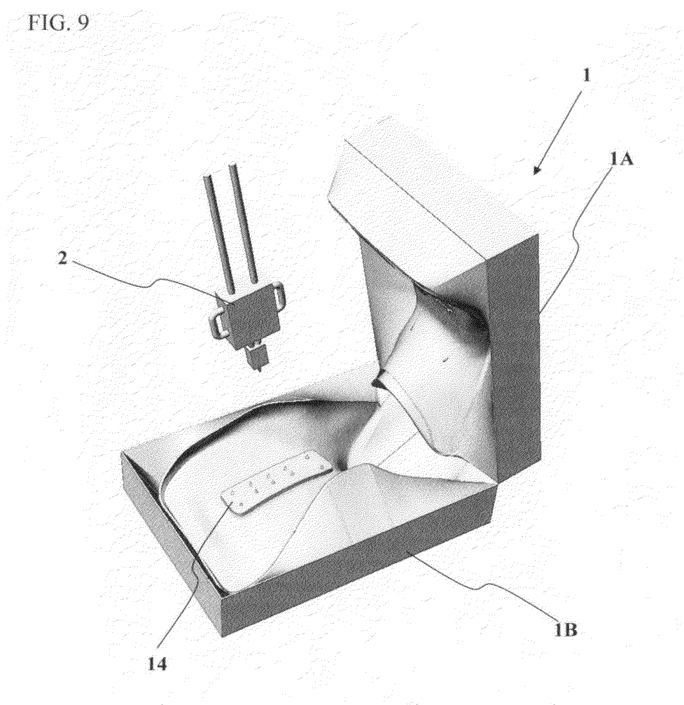

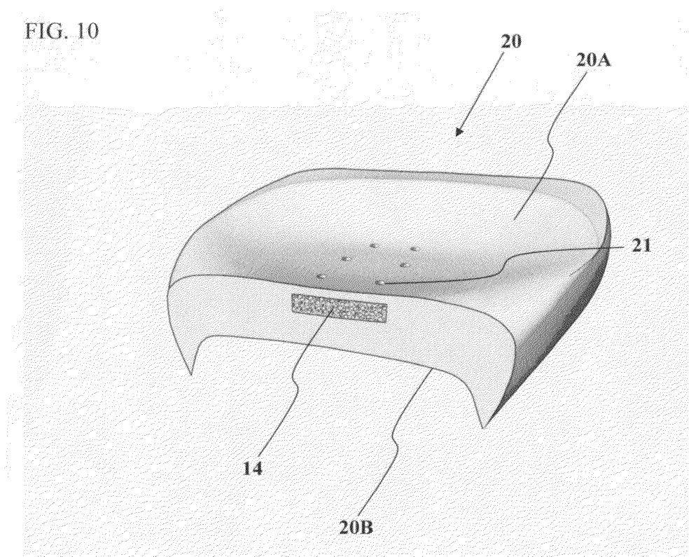

With the background previously provided, especially in regard to FIG. 1, the teachings and novelty of FIGS. 2 and 3 can be better appreciated. These drawing figures illustrate a first preferred embodiment of a seat insert 10 in accordance with the teachings of my invention. As will be noted, both versions illustrated feature foam dispersion and distribution openings/vents 11 scattered across their surfaces, mounting peg openings 12, and a perineal opening 13, with the version of the first embodiment illustrated in FIG. 3 varying from that in FIG. 2 by virtue of the inclusion of a sub insert/perineal insert 14 of super-light density foam in perineal opening 13. A third embodiment is illustrated in FIG. 7, where perineal opening 13 forms a gap completely separating the two halves of seat insert 10. (Another embodiment, this time restricted only to the use of perineal insert 14, is illustrated in FIGS. 9 and 10). In the embodiments having larger inserts 10, it is generally advantageous to include openings 11 so that reacting liquid 30 can freely move through and around the seat inserts 10 so that there are no unfilled gaps left in the molded seat 20. These holes/openings 11 may be of varying size, frequency of distribution or not included at all, depending on the flow characteristics and/or requirements of each particular mold/insert/seat.

For most large inserts 10, perineal opening 13 has been found sufficient by itself for the aforesaid purpose without the inclusion of openings 11. However, its primary purpose is to create, include and incorporate a softer area or cushion below the perineum of the person seated on seat 20, as the perineum is more sensitive than surrounding areas for many people. By leaving the perineal opening 13 unfilled (as illustrated in FIG. 2), this area will be filled with the somewhat softer polyurethane foam making up the remainder of seat 20. Alternately, as illustrated in FIGS. 3, 9 and 10, a sub-insert/perineal insert 14 of super-light density foam provides an even softer substrate for this same purpose. Thus, in the version of seat insert 10 illustrated in FIG. 2 (and FIG. 7) openings 11 will generally be found to be unnecessary, but in the version of insert 10 illustrated in FIG. 3, they will serve a valuable purpose in allowing the complete and even spreading of reacting liquid 30 so that no gaps remain. As will be appreciated from the drawing figures (and in accordance with their anatomical purpose of underlying the perineal regions of a user), perineal opening 13 and perineal inserts 14 are preferably elongate, which shape defines a long axis that will be aligned with the bilateral axis of the user when seated on seat 20, and serve to separate seat 20 and/or mat/insert 10 into two halves, each of which would support, anatomically, respective buttocks/thighs of the user.

Insert 10 is preferably formed from closed cell foam with characteristics important to the purposes of my invention, though other materials having similar characteristics or other chosen characteristics can be used for this purpose. One such characteristic is “Compression Set”, a property that describes the fact that a permanent foam setting or deformation is achieved when a load is place on the seat insert 10 over a period of time. In the instant application this is advantageous because it allows the insert to form itself to the contours of the user's body over a period of time, adapting itself to the particular shape and configuration of the user for added user comfort. Vinyl nitrile foam has been found ideal for these purposes. Another important property of any such insert 10 is “rebound” (or spring-like performance), which is a property of vinyl nitrile foam by virtue of its closed cell construction. The inclusion and incorporation of insert 10 in molded seat 20 results in a final molded foam composite (seat 20) that is enhanced with these added properties derived from insert 10. However, as previously mentioned, other materials may be useful for this purpose, particularly other closed cell foam materials.

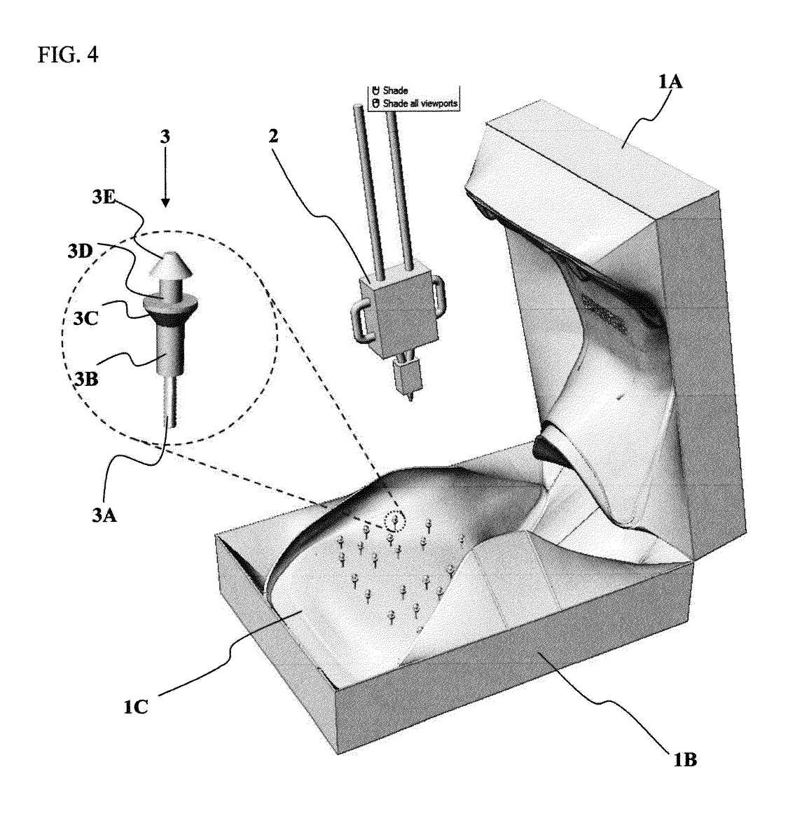

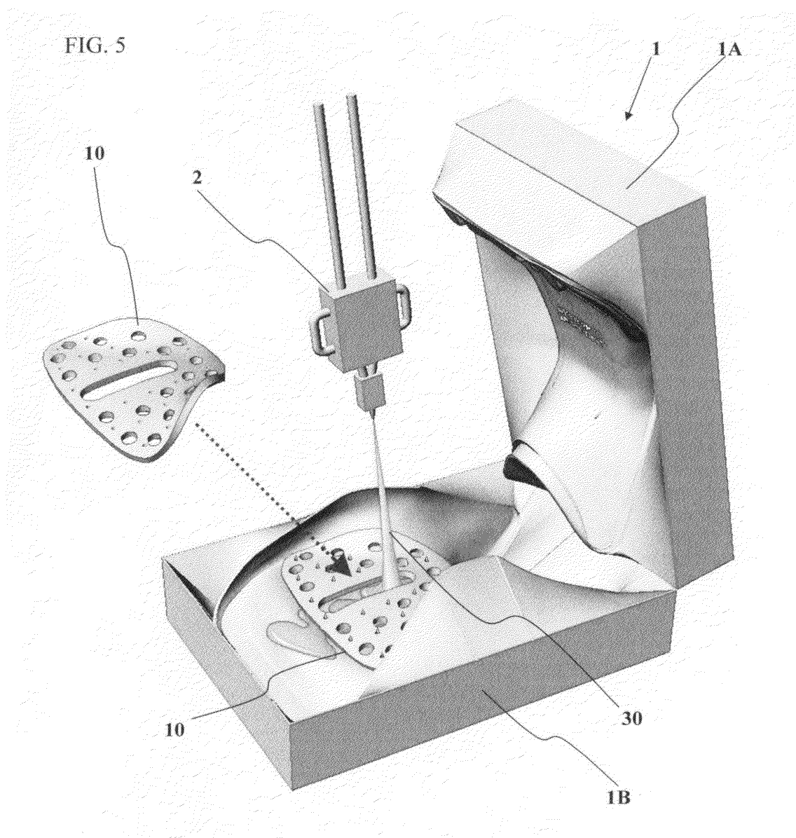

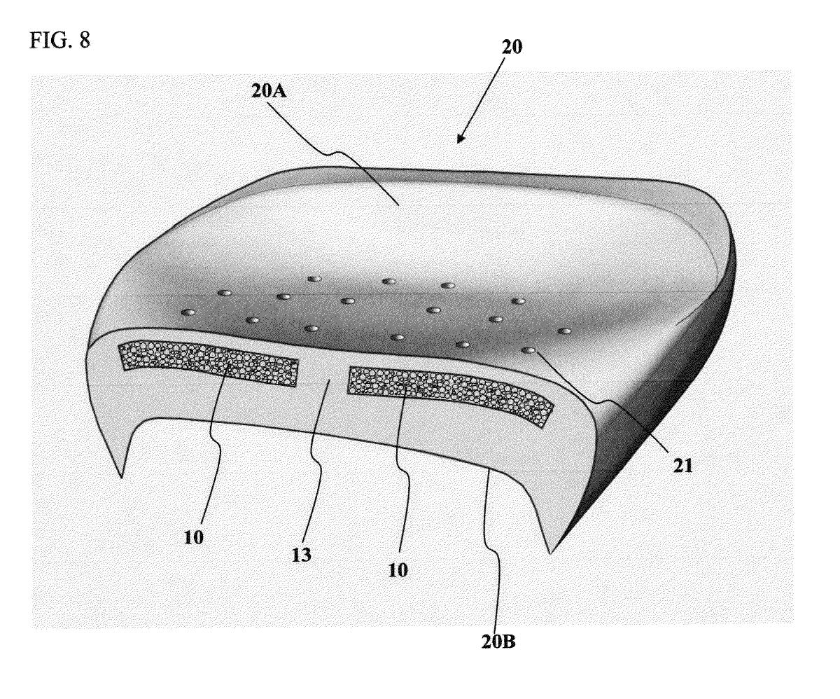

Review of FIGS. 4 through 6 provide insight into the manner in which, and apparatus used, to adapt the mold 1 of FIG. 1 for placement and support of a seat insert 10 therein in a position intermediate upper mold half 1A and lower mold half 113. In this position it will be completely enveloped and surrounded by polyurethane foam as part of the reaction injection molding process previously described and thereby completely encapsulated in, enveloped by, and embedded in, the seat 20 formed thereby. (See, e.g., FIG. 8). This is accomplished by the inclusion of appropriately spaced and configured support pegs 3 in mold space 1C, preferably via mounting/attachment of said pegs 3 to lower mold part 1B as illustrated in FIG. 4.

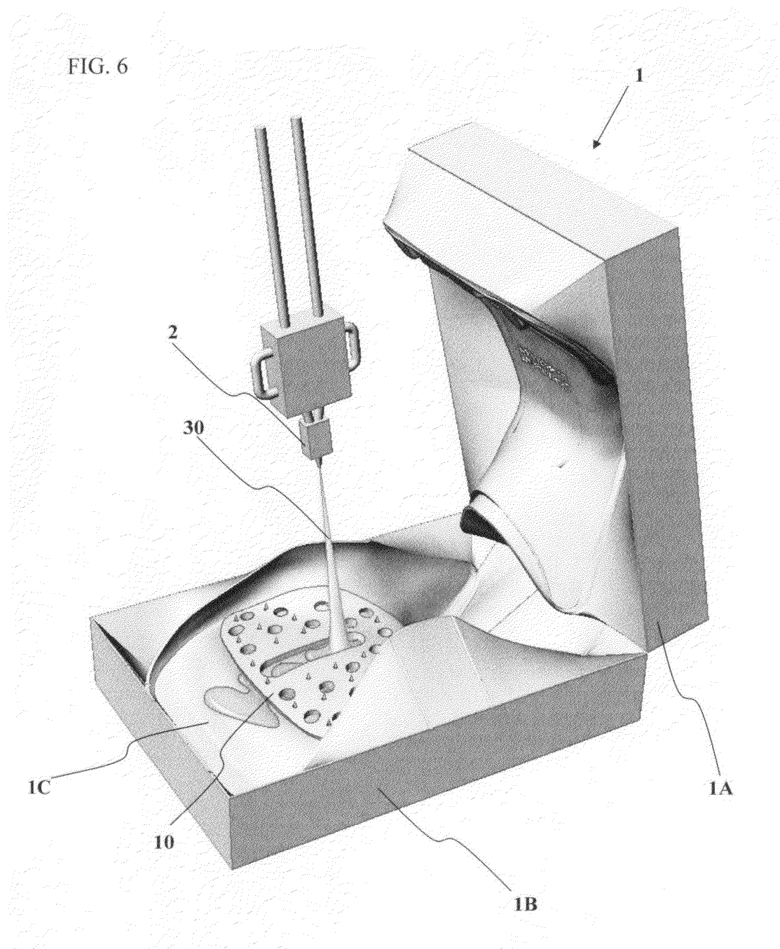

As will be noted, pegs 3 can be advantageously formed with a base portion 3A (adapted for insertion in a registering opening provided in mold base portion 3A), support portion 3B (which holds the insert 10 in place within the mold 1 in spaced relationship to the upper mold portion 1A and lower mold portion 1B when the mold 1 is closed), a ledge portion 3C (with a substantially conical shape providing direct support of the insert 10 from below while allowing the seat 20 to be withdrawn—due to its sloped portion—from the mold 1 when it is formed), a barrel section 3D (dimensioned in terms of diameter and length to fit the width of mounting peg openings 12 and the thickness of insert 10), and a substantially conical head 3E (adapted to push through the somewhat flexible material of insert 10 while holding the insert 10 in place from above). Thus, insert 10 can be pressed onto the pegs 2 in mold 1 (as illustrated in FIGS. 5 and 6) so as to be positioned adjacent barrel section 3D so as to be held firmly in place between ledge portion 3C and head 3E through the molding process, and both insert 10 and seat 20 can be freed from pegs 3 and pulled out of mold 1 (i.e., easily de-molded), when the molding process is complete. When removed, as illustrated in FIG. 8, the seat 20 of the invention will feature a completely embedded and encapsulated insert 10 having the features previously described. Similarly, FIGS. 9 and 10 illustrate the aforesaid teachings and techniques as applied to a perineal insert 14, when used without a seat insert 10.

### PARTS AND FEATURES ILLUSTRATED IN DRAWING FIGURES

1 Mold
1A upper mold part
1B lower mold part
2 Dispenser
3 Pegs
3A base portion
3B support portion
3C ledge portion
3D barrel section
3E conical head
10 Insert
11 Insert openings
12 Mounting peg openings
13 Perineal opening
14 Sub-insert or Perineal insert
20 Seat
20A upper surface of seat (molded by lower mold part 1B)
20B lower surface of seat (molded by upper mold part 1A)
21 Openings left in seat 20 by part 3B

In view of the foregoing, it should be clear that numerous changes and variations can be made without exceeding the scope of the inventive concept outlined. Thus, though the preferred embodiment is illustrated in the context of a motorcycle seat, the teachings of the invention are not necessarily restricted to such seats. Further, though the preferred materials comprising the seat are specified, other materials with similar support and/or molding characteristics may certainly be substituted. In addition, though single layer mats/inserts are shown, the inventive concept does not preclude multiple mat/insert layers or further subdivision of the mat/insert in terms of its constituent materials than those shown. Accordingly, it is to be understood that the embodiment(s) of the invention herein described is/are merely illustrative of the application of the principles of the invention. Reference herein to details of the illustrated embodiment(s) is not intended to limit the scope of the claims, which will themselves recite those features regarded as essential to the invention.

I claim:

1. A seat, comprising:
an insert embedded in a resilient outer layer; and
wherein said insert comprises at least one of:
a seat insert adapted to underly the buttocks of a user and comprising a semi-rigid mat having at least one of rebound characteristics, and compression set characteristics, and
a perineal insert adapted to underly the perineum of a user and comprising a material softer than the resilient outer layer.

2. The seat of claim 1, wherein at least one of: said seat insert is comprised of closed cell foam, said perineal insert is comprised of super light density foam, and said resilient outer layer is comprised of reaction injection moldable foam.

3. The seat of claim 1, wherein any said insert is completely encapsulated by said resilient outer layer, any said seat insert is comprised of vinyl nitrile closed cell foam, and said resilient outer layer is comprised of polyurethane foam.

4. The seat of claim 1, wherein said seat has an upper surface and a lower surface, and any said insert is at least one of substantially parallel to said upper surface, and intermediate said upper and lower surfaces.

5. The seat of claim 1, wherein said seat insert includes a perineal opening located so as to be underneath the perineal area of a user when seated on said seat.

6. The seat of claim 5, wherein said perineal opening includes a sub-insert of at least one of: a material softer than the resilient outer layer and a super-light density foam.

7. A seat, comprising:
an insert embedded in a resilient outer layer;
wherein said insert comprises at least one of a seat insert adapted to underly the buttocks of a user and comprising a semi-rigid mat having rebound characteristics and compression set characteristics, and a perineal insert adapted to underly the perineum of a user and comprising a material softer than the resilient outer layer;
wherein said seat has an upper surface and a lower surface, and any said insert is at least one of: substantially parallel to said upper surface, and intermediate said upper and lower surfaces; and
wherein any said insert is completely encapsulated by said resilient outer layer.

8. The seat of claim 7, wherein at least one of: said seat insert is comprised of closed cell foam, and said resilient outer layer is comprised of reaction injection moldable foam.

9. The seat of claim 7, wherein any said seat insert is comprised of vinyl nitrile closed cell foam, any said perineal insert is comprised of super-light density foam, and said resilient outer layer is comprised of polyurethane foam.

10. The seat of claim 7, wherein said seat insert includes a perineal opening located so as to be underneath the perineal area of a user when seated on said seat.

11. The seat of claim 10, wherein said perineal opening includes a sub-insert of at least one of a material softer than the resilient outer layer and a super-light density foam.

12. A method for molding a seat, comprising:
providing a seat mold defining the shape of a seat having upper and lower surfaces;
positioning at least one insert in said mold so as to be intermediate said upper and lower surfaces when said mold is closed;
injecting a reacting expanding liquid into said mold such that said liquid will expand to fill said mold, forming a resilient outer layer surrounding said at least one insert; and
wherein said at least one insert at least one of: has a different density than the resilient outer layer, is softer or harder than the resilient outer layer, has greater or lesser stiffness than the resilient outer layer, has greater ability to conform to the user's body than the resilient outer layer, and is more springy than the resilient outer layer.

13. The seat of claim 12, wherein said at least one insert comprises at least one of
a seat insert adapted to underly the buttocks of a user and comprising a semi-rigid mat having at least one of rebound characteristics, and compression set characteristics, and
a perineal insert adapted to underly the perineum of a user and comprising a material softer than the resilient outer layer.

14. The seat of claim 13, wherein at least one of said seat insert is comprised of closed cell foam, said perineal insert is comprised of super-light density foam, and said resilient outer layer is comprised of reaction injection moldable foam.

15. The seat of claim 13, wherein any said insert is completely encapsulated by said resilient outer layer, any said seat insert is comprised of vinyl nitrile closed cell foam, and any said insert is substantially parallel to said upper surface.

16. The seat of claim 13, wherein said seat insert includes a perineal opening located so as to be underneath the perineal area of a user when seated on said seat.

17. The seat of claim 16, wherein said perineal opening includes a sub-insert of at least one of: a material softer than the resilient outer layer and a super-light density foam.

18. The method of claim 13, wherein said insert is completely encapsulated by said resilient outer layer.

19. The method of claim 13 wherein openings in said seat insert aid said reacting expanding liquid in expanding through and around said seat insert so as to fill said mold.

20. The method of claim 19, wherein said perineal opening aids said reacting expanding liquid in expanding through and around said insert so as to fill said mold.

21. The method of claim 13, wherein pegs extending from one of said surfaces support said at least one insert in said mold so as to be intermediate said upper and lower surfaces when said mold is closed.
